(19) United States
(12) Patent Application Publication
(10) Pub. No.: US 2010/0031050 A1
(43) Pub. Date: Feb. 4, 2010

(54) PERMANENT DISPLAY AND AUTHENTICATION OF STATUS INFORMATION OF A TECHNICAL DEVICE

(75) Inventors: Stefan Schulz, Himmelpforten (DE); Carsten Vogel, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/509,585

(22) Filed: Jul. 27, 2009

Related U.S. Application Data
(60) Provisional application No. 61/137,837, filed on Aug. 4, 2008.

(30) Foreign Application Priority Data
Aug. 4, 2008 (DE) 10 2008 036 263.8

(51) Int. Cl. H04L 9/32

(52) U.S. Cl. 713/176

(57) ABSTRACT

The invention relates to an arrangement and a method for the acquisition and verification of at least one aspect of status information of a technical device, in particular for checking the software version. In order to make it possible to simply and reliably check the current software version the technical device comprises a storage device, a processing unit and a display, wherein the storage device comprises at least one software required for operating the technical device, a software version number and security data for calculating an identification characteristic to be graphically displayed. The security data is deposited in an encrypted region of the storage device. With the use of the processing unit the identification characteristic can be calculated on behalf of the software version number and the security data. The display displays information even in a current-free state without the use of an external energy source.

### CROSS-REFERENCE TO RELATED APPLICATIONS

The present application claims the benefit of the filing date of U.S. Provisional Patent Application No. 61/137,837 filed Aug. 4, 2008, the disclosure of which is hereby incorporated herein by reference.

### BACKGROUND OF THE INVENTION

The invention relates to an arrangement and a method for the acquisition and verification of at least one aspect of status information of a technical device, in particular for checking the software version. Particularly, the invention relates to a device and a system for the acquisition and verification of at least one aspect of status information of a technical device.

A multitude of technical devices these days provides the option of replacing the internal operating software by newer software versions. This may be of importance in particular when functions of a device need to be changed or adapted. However, in many devices it is not possible, from the outside or without the use of external equipment, to detect the software version with which the particular device is operated, i.e. to detect which software version is installed in the technical device. This can cause problems when identical devices that comprise different software versions are brought together in a system. Detecting the installed software version is, for example, also required, for example when a device needs to be exchanged. In this process it may be necessary for the device to be exchanged and for the device to be installed to replace it to have identical software versions or certain different software versions in order to incorporate the new device in the system, and to ensure proper functioning of the system. In order to solve this problem of detecting the software version, for example the use of stickers is known. However, during a software update the sticker needs to be exchanged or the label needs to be manually altered so that subsequently the updated information is displayed. In order to avoid the need to exchange stickers or to laboriously manually alter the information on the label, devices are known in which the currently loaded software version is shown on a display; an arrangement that, however, only works if the device actually has a display, and even then only when the device is in operation. However, it has been shown that existing arrangements of showing the currently loaded software version are very cumbersome, both from the point of view of affixing it and from the point of view of querying it. There is a further problem, in particular in the case of sensitive control- and regulating components, in that, prior to installation or even prior to use, it may be necessary, e.g. for security-related reasons, to unequivocally identify the software, or the hardware in conjunction with the software, and to verify or authenticate their correctness. To this effect, for example, elaborately produced stickers, for example incorporating integrated holograms, are known.

### BRIEF SUMMARY OF THE INVENTION

It may be an object of the present invention to provide an arrangement and a method by which the current software version number can simply and reliably be provided and checked.

According to an exemplary embodiment of the invention, the technical device comprises a storage device, a processing unit and a display, wherein the storage device comprises at least one software that is required for operating the technical device, a software version number and security data for calculating an identification characteristic that is to be graphically displayed, wherein the security data is deposited in an encrypted region of the storage device, wherein by the processing unit at least one identification characteristic and data for displaying the at least one identification characteristic can be calculated on behalf of the software version number and the security data, wherein the display is a permanent information display that displays information even in a current-free state without the use of an external energy source, wherein the display shows at least the identification characteristic, and wherein the software can be authenticated by the identification characteristic.

The invention provides an advantage in that the status information is displayed on the display even if the device is not in operation, in other words if there is no energy supply. It is thus possible at all times to read the status information. Moreover, depositing security data in an encrypted region of the storage device provides an additional security benefit. Security data is, for example, deposited in the storage device already during production of the technical device, and is combined with the associated parts number of the device. Moreover, a corresponding mathematical interrelationship or a calculation rule is generated and deposited in the device. The correct content of the display, i.e. the correct identification characteristic, which is generated from the calculation, is not itself deposited in the device. In the case of an incorrect software version number the display will display this difference. Consequently it is not only possible to identify the status information, i.e. the current software version number of the software installed in the device, but in addition it is possible to determine whether it is the correct software. During installation of new software the device receives a new software version by way of an interface, which software version is placed in the internal storage device. The software package contains a region or a block which contains the suitable version number. Since during the entire software renewal process an energy source is inevitably always present, it is possible during this procedure to control the display on the device and to adapt it to the current circumstances. Consequently during the software renewal process the display obtains the new matching information. The display then shows that the corresponding new software version is installed in the device. Since the display is a permanent information display that continues to display information even without an external energy supply, the information continues to be visible even after completion of the software updating process, when there is no longer any energy supply. If the software version number or the security data has been falsified, i.e. is incorrect, inevitably an “incorrect” identification characteristic is displayed. The security data is one-time data, for example a one-time number, comparable to a MAC address.

In a preferred embodiment the display shows the current software version number. Furthermore, it may be provided for the displayed identification characteristic to be a digital watermark, and for plausibility of the allocation of software version the number and the watermark to be verifiable in a database. In this arrangement the database is, for example, provided by the manufacturer. The display of the current software version number makes it possible to directly read the software version installed in the device, i.e. checking as to whether on the device the correct software for the particular purpose is stored can take place in the easiest possible manner. Furthermore, a plausibility check can be carried out in a simple manner by comparing the allocation of the software version number and the watermark on the display with the corresponding allocations in a database.

Other information can also be shown on the display, e.g. the date of the last update, or other device-specific data.

In a further preferred embodiment the watermark may comprise numbers and/or letters. The watermark is thus displayed as plain text, which means that it is simple to read or detect the watermark, so that the plausibility check procedure is still further simplified. On behalf of the plain text information and the software version number it is possible, for example, by a comparison with the corresponding associations in a table generated on behalf of the database, to check whether the data in the device is consistent and correct.

In a further preferred embodiment variant the identification characteristic may be a code that can be acquired with a reading device, wherein the code shown can be authenticated on behalf of a database. For example, the code is a bar code. The use of a code makes possible an acquisition and thus also an authentication process with a reading device designed for this, and consequently reading errors can be reduced to a minimum. For authentication, the data from the reading device can be communicated to a further device in which the data is authenticated on behalf of a database.

In a further preferred embodiment the database can be deposited in the reading device so that for authentication only the reading device is required without there being a need for connection or communication to a further device. The database can, for example, be updated or synchronised by way of an interface of the reading device.

In a further preferred embodiment variant the software version number may be displayed on the display; the security data can be read out and decrypted with the use of a reading device; and the software can be authenticated by a comparison of the decrypted security data with the comparison security data that can be calculated on behalf of the displayed software version number and the displayed identification characteristic. This makes possible an authentication that does not require a database to be provided by the manufacturer and to be updated. Instead, only a reading device is required in which the required information for decryption is deposited. While this involves additional security requirements in relation to the reading device, it does, however, allow a reliable and safe checking of the current software version. For example, if the displayed software version number and the displayed identification characteristic are automatically entered into the reading device by said reading device, e.g. by of a bar code, incorrect operation or incorrect checking of the software version or of other status information is impossible.

In a particularly preferred embodiment a device may comprise one of the abovedescribed arrangements, wherein the device is an aeronautical device. Providing the arrangement according to the invention in one of the embodiments described in an aeronautical device is of particular importance against the background of the special requirements in relation to the individual technical components in the aeronautical sector. For example, aeronautical devices are subject to very stringent safety requirements. By displaying the software version number on the display, already prior to installation or prior to handling the device it is possible to determine whether the device is the correct device with the correct software version. For example, identical devices with various software versions can be kept in a spare parts store, in which devices the selection of the correct version depending on a given application is possible in a simple way because the actual software version can be acquired even without installing and operating the device. Authentication furthermore ensures that the aeronautical device has the appropriate software version, instead of having a forgery that does not function properly, which can happen in particular in more expensive devices. Since aircrafts of an operating company, for example an airline, are these days serviced, maintained and repaired at various locations in various countries, fault-free and reliable authentication of aeronautical devices is of special importance. Language problems and communication problems, the various standards and regulations, as well as, last but not least, the different qualifications and levels of training and instruction of the ground personnel engaged in repair and maintenance are mentioned just as an aside.

The invention also relates to a system with at least one aeronautical device, as described above, and at least one reading device by which the information shown on the display can be read out. The use of such a system in various locations may ensure uniform authentication processes and thus uniform and reliable spare parts logistics that meet the requirement of globalisation in aviation.

In a preferred embodiment of the method the following steps may be provided: calculating, in a processing unit, an identification characteristic that is to be displayed graphically, on behalf of a current software version number stored in a storage device and security data deposited in the storage device, for calculating the identification characteristic; communicating the presentation data to a permanent display, which displays information also in a current-free state without the use of an energy source; adjusting the display to the communicated presentation data; presenting the identification characteristic without the use of an energy source; and authenticating the software on behalf of the identification characteristic. Since the security data is deposited in a protected, i.e. encrypted, region of the storage device, and since the computing process cannot be influenced from the exterior, the method according to the invention ensures that the displayed data cannot be manipulated from the outside. The method can, for example, during installation of new software be activated automatically so that the display is always up to date. Since the display is a permanent display, e.g. a so-called bi-stable display, the information is also available beyond the period of time of updating, i.e. also later on when an energy supply is no longer present. It is thus not necessary to provide batteries or accumulators in the device in order to present the information and make it readable on the display. In this way there is no maintenance work, such as charging or replacing accumulators, that would otherwise be necessary, nor are there any sources of error and security risks that are associated with failure of the energy supply. Furthermore, apart from cost savings this also entails a significant reduction in weight and in the number of components. The latter two aspects are of fundamental importance in particular in the field of aviation, because they have a direct influence on fuel consumption and options of use of the aircraft, i.e. their effects relate both to economy and ecology.

In a particularly preferred embodiment of the method the current software version number may be shown on the display, and the identification characteristic is shown as a digital watermark, wherein the plausibility of the allocation between the software version number and the watermark is verified in a database. In this way the software version can be acquired and controlled with ease. The database is, for example, provided by the manufacturer and offers the required security during authentication, because said database is not present in the device itself.

In a further preferred embodiment the watermark may be displayed in numbers and/or letters in order to further simplify the process of reading it. This suggests itself, for example, in cases when it is not possible to access additional equipment for authentication, e.g. in the case of repair work at smaller airports, for example in third-world countries. Authentication can then, for example, take place by printed-out tables in which the associations of software version numbers and watermarks are shown.

In one embodiment variant the identification characteristic may be shown as a code that is read out with the use of a reading device, and the software is identified on behalf of a database. The code can, for example, be a bar code, for example a two-dimensional or three-dimensional bar code. In this way the reliability can be improved because read-out errors can be excluded. Furthermore, the process itself can be accelerated because it can take place automatically in the reading device. The database can, for example, be deposited in the reading device, or the reading device is in at least partial and temporary connection with the database by way of an interface.

In a further embodiment variant the following steps may be provided: displaying the software version number on the display; reading out the security data with a reading device; decrypting the security data in the reading device; reading the displayed software version number; calculating comparison security data on behalf of the displayed software version number and the displayed identification characteristic; and authenticating the software by comparing the calculated comparison security data with the decrypted security data. In this method, synchronisation with a database is not required. In this arrangement security is ensured by the decryption deposited in the reading device.

### BRIEF DESCRIPTION OF THE DRAWINGS

Below, for further explanation and to provide an improved understanding, the invention is described in more detail with reference to exemplary embodiments by means of the enclosed drawings. The following are shown:

FIG. 1 shows a diagrammatic view of a device with an arrangement for the acquisition and verification of at least one aspect of status information;

FIG. 2 shows a diagrammatic view of the method-related steps of a first exemplary embodiment;

FIG. 3 shows a diagrammatic view of the method-related steps of a further exemplary embodiment; and

FIG. 4 shows a diagrammatic view of the method-related steps of a further exemplary embodiment.

### DETAILED DESCRIPTION

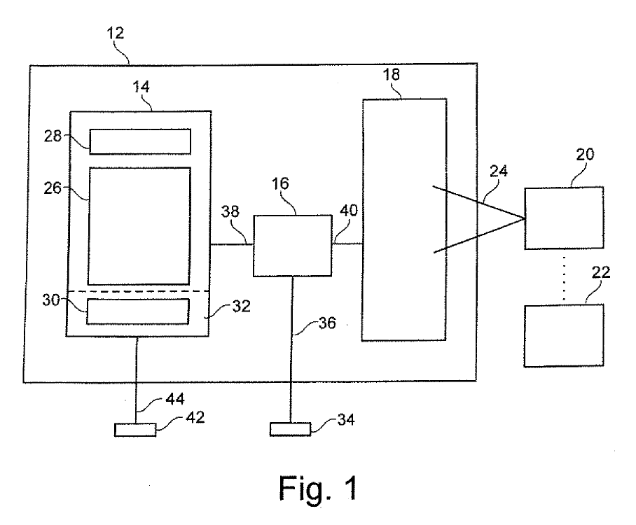

FIG. 1 shows a technical device 12, for example an aeronautical device, i.e. a device that is used for flight operation in an aircraft. The device 12 comprises a storage device 14, a processing unit 16 and a display 18 that can be read from the outside. Said display 18 is a permanent information display that displays information also in a current-free state, i.e. without the use of an external energy source. This ensures that the information to be displayed can also be read when the device is not supplied with energy, for example in its switched-off or even in its deinstalled state.

Also shown is an external reading device 20 which can, for example, be linked to a database 22. The reading device 20 is used for reading the information displayed on the display 18, which in the drawing is indicated by an angle 24.

The storage device 14 may comprise at least one software 26 necessary to operate the technical device 12, a software version number 28, and security data 30 to calculate an identification characteristic that is to be graphically displayed. The security data 30 is deposited in an encrypted region 32 of the storage device 14. Furthermore, on the technical device 12 a first interface 34 is provided, by which, for example, new software can be transmitted to the storage device 14, for which purpose a connection 36 between the interface 34 and the processing unit 16 is provided, which in turn by way of a connection 38 is connected to the storage device 14, and by way of a connection 40 is connected to the display 18. For the sake of clarity, any further connections that may be present between the processing unit 16 or the storage device 14 with other components (not shown) of the technical device, i.e. hardware, are not shown. The connection for data transmission can be designed so as to be wired or wireless. A second interface 42 may be provided, which is connected to the storage device 14 by way of a connection 44 and by which interface the storage device 14 or a particular region of the storage device 14, e.g. the encrypted region 32, can be read out.

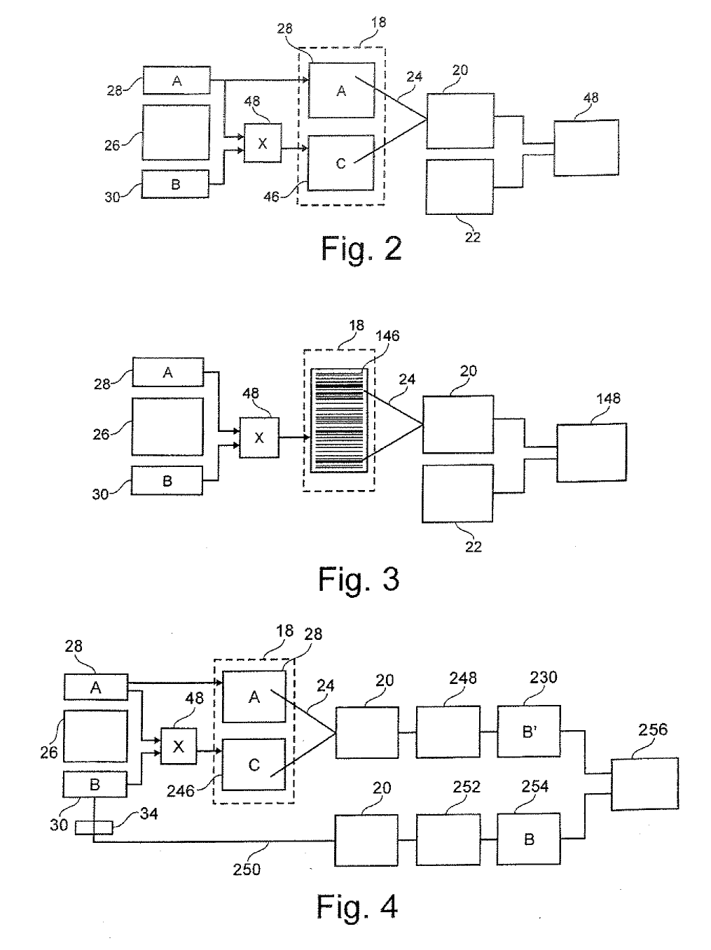

In the embodiment variant shown in FIG. 2 the software version number 28, also designated with A in FIG. 2, is transmitted to the display 18 and may be shown therein.

The software version number 28 is moreover transmitted to the processing unit 16. In addition, the security data 30, also designated with B in the illustration, is transmitted to the processing unit 16 for calculation 48 of an identification characteristic 46, to be shown graphically, which identification characteristic 46 in the figure is also designated with C. In the processing unit 16, mathematical linking of the software version number 28 and the security data 30 takes place (wherein in FIG. 2 the arithmetic process 48 is also designated with X) in order to calculate data for displaying an identification characteristic 46.

This presentation data is transmitted to the permanent display 18 so that an adjustment of the display or of a part of the display to the transmitted presentation data takes place. After this, the display 18 shows not only the software version number 28, i.e. A, but also the identification characteristic 46, i.e. C. The information is also displayed if the energy supply is removed, because the display 18 is, for example, a bi-stable display.

The identification characteristic C (46) is, for example, a digital watermark. By reading 24 the software version number A (28) and the identification characteristic C (46), for example by the reading device 20, checking 48 of the allocation of the software number A and the watermark C becomes possible on behalf of the database 22.

In a further variant of the method, which variant is shown in FIG. 3, from the software version number A (28) and the security data B (30) a code 146, as an identification characteristic, is calculated in the processing unit 16 (the arithmetic process 48 is again denoted with X). The code 146 is shown on the display 18. Subsequently the code 146, which is, for example, a barcode, can be read out by the reading device 20 in a reading procedure 24, and the information relating to the software 26, which information is contained in the code 146, can be authenticated in an authentication step 148 with reference to the database 22.

The method shown in FIG. 4 is a further variant in which the software version number A (28) is displayed on the display 18. Furthermore, on behalf of the software version number 28 and the security data B (30), in the arithmetic logic unit 16 in an arithmetic step 48 (again designated with X) an identification characteristic 246 is calculated, which identification characteristic 246 is shown on the display 18 as an identification characteristic C. As a result of reading 24 the software version number A (28) and the identification characteristic C (246) by the reading device 20, the security data 30, i.e. B, can be formed in an arithmetic step 248 by recombination, in other words comparison security data B′ (230) can be calculated. By way of the second interface 42, which is already shown in FIG. 1, and which in the description is also mentioned in this context, the encrypted security data 30 (B) can be read out with the reading device 20 in a reading step 250.

In order to obtain the security data 30, decryption 252 takes place by the reading device 20, by which decryption 252 security data 254 is provided that corresponds to the security data B, i.e. 30, in the encrypted region 32 of the storage device 14. The reading device 20 is preferably the same reading device 20 that is also used for reading the display 18. In the drawing the reading device 20 is shown as two separate boxes to provide an improved understanding of the two processes of recombination 248 and decryption 252 only.

Since now the security data 30 (B) and the comparison security data 230 (B′) are present, authentication of the software 26 by a comparison 256 between the calculated comparison security data B′ and the decrypted security data B becomes possible.

Instead of reading or entering the software version number A and the identification characteristic C, the two pieces of information (A, C) can also be shown as a bar code to be acquired automatically by the reading device.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

1. An arrangement for the acquisition and verification of at least one aspect of status information of a technical device, comprising:
a storage device,
a processing unit, and
a display;
wherein the storage device further comprises a software required for operating the technical device, a software version number, and security data for calculating an identification characteristic to be graphically displayed;
wherein the security data is deposited in an encrypted region of the storage device;
wherein at least one identification characteristic and data for displaying the at least one identification characteristic can be calculated by the processing unit on behalf of the software version number and the security data;
wherein the display is a permanent information display that displays information even in a current-free state without the use of an external energy source;
wherein the display shows at least the identification characteristic, and
wherein the software can be authenticated on behalf of the identification characteristic.

2. The arrangement of claim 1, wherein the current software version number is shown on the display, the identification characteristic is a digital watermark, and the plausibility of the allocation of the software version number and the watermark is verifiable in a database.

3. The arrangement of claim 2, wherein the watermark further comprises numbers and/or letters.

4. The arrangement of claim 1, wherein the identification characteristic is a code that can be acquired with a reading device,
wherein the read-out code can be authenticated on behalf of a database.

5. The arrangement of claim 4, wherein the identification characteristic is a bar code.

6. The arrangement of claim 4, wherein the database can be deposited in the reading device.

7. The arrangement of claim 1, wherein
the software version number is displayed on the display;
the security data can be read out and decrypted with the use of a reading device; and
the software can be authenticated by a comparison of the decrypted security data with the comparison security data that can be authenticated on behalf of the displayed software version number and the displayed identification characteristic.

8. A device comprising an arrangement of claim 1, wherein the device is an aeronautical device.

9. A system comprising at least one device of claim 8 and at least one reading device by which the information shown on the display can be read out.

10. A method for the acquisition and verification of at least one aspect of status information of a technical device, comprising the steps of:
calculating, in a processing unit, an identification characteristic that is to be displayed graphically, the step of calculating being based on a current software version number stored in a storage device and security data deposited in the storage device;
communicating presentation data to a permanent display, which displays information also in a current-free state without the use of an energy source;
adjusting the display to the communicated presentation data;
presenting the identification characteristic without the use of an energy source; and
authenticating the software on behalf of the identification characteristic.

11. The method of claim 10, wherein the current software version number is shown on the display, and the identification characteristic is shown as a digital watermark, wherein the plausibility of the allocation between the software version number and the watermark is verified in a database.

12. The method of claim 11, wherein the watermark is displayed in numbers and/or letters.

13. The method of claim 10, wherein the identification characteristic is shown as a code that is read out with a reading device, and the software is authenticated on behalf of a database.

14. The method of claim 10, further comprising the steps of:
displaying the software version number on the display;
reading out the security data with a reading device;
decrypting the security data in the reading device;
reading the displayed software version number;
calculating comparison security data on behalf of the displayed software version number and the displayed identification characteristic; and
authenticating the software by comparing the calculated comparison security data with the decrypted security data.
